(19) United States
(12) Patent Application Publication
(10) Pub. No.: US 2004/0120164 A1
(43) Pub. Date: Jun. 24, 2004

(54) Power control system for display apparatus

(75) Inventor: Chang-Kwun Kwak, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/702,656

(22) Filed: Nov. 7, 2003

(30) Foreign Application Priority Data
Dec. 20, 2002 (KR) 2002-81906

(51) Int. Cl. H02M 3/335

(52) U.S. Cl. 363/21.01

(57) ABSTRACT

A power control system for a display apparatus includes a rectifying part converting AC power to DC power, a switching transformer transforming a DC voltage outputted from the rectifying part into an output voltage applied to the display apparatus, and a switching controller controlling a switching operation of the switching transformer. The power control system further includes a feedback winding provided in the switching transformer to generate a feedback current induced by a primary winding of the switching transformer and to provide the induced current to the switching controller, a micro controller generating a switching driving signal synchronizing with a horizontal synchronizing signal provided from a computer body in a normal mode and generating a power saving mode signal to reduce the output voltage of the switching transformer in a power saving mode, and a synchronous circuit part receiving the switching driving signal or the power saving mode signal from the micro controller and providing the switching driving signal or the power saving mode signal to the switching controller. Thus, in a power off mode of a power saving mode, a power saving efficiency is increased by minimizing the output voltage outputted from the switching transformer. Also, noise can be reduced by stabilizing the output voltage outputted from the switching transformer and by synchronizing a frequency (output timing) of the output voltage with the horizontal synchronizing signal.

### CROSS-REFERENCE TO RELATED APPLICATIONS

This application claims the benefit of Korean Patent Application No. 2002-81906, filed Dec. 20, 2002, in the Korean Intellectual Property Office, the disclosure of which is incorporated herein by reference.

### BACKGROUND OF THE INVENTION

1. Field of the Invention

The present invention relates to a power control system for a display apparatus, and more particularly, to a power control system for a display apparatus reducing an output of a secondary winding of a switching transformer provided in a power supply part in a power saving mode, thereby reducing a power consumption of the display apparatus.

2. Description of the Related Art

A display apparatus displays images on the screen by receiving a video signal and synchronizing signals transmitted from a computer system. Recently, a switching mode power supply (SMPS) applying voltages necessary for respective parts of the display apparatus in a high efficiency is used as a power supply part supplying operation power to the display apparatus. Generally, most modern display apparatuses have power saving functions to comply with VESA's Display Power Management System protocol, also called DPMS. According to whether a horizontal synchronizing signal and a vertical synchronizing signal transmitted from a computer system body exist, power saving modes of the display apparatus complying with the DPMS are classified into a normal mode in which the two synchronizing signals are all provided, a stand-by mode in which only the vertical synchronizing signal is provided, a suspended mode in which only the horizontal synchronizing signal is provided, and a power off mode in which both of the two synchronizing signals are not provided. Due to the power saving function of the display apparatus, a computer can reduce a power consumption in a case that the computer is not used with its power on. As a non-use time of the computer increases, the power saving mode is changed from the normal mode to the stand-by mode, and then to the suspended mode and the power off mode in sequence. Accordingly, the power consumption is decreased gradually, and commonly, the power consumption is regulated 5W or less.

FIG. 3 illustrates a configuration to process a DPMS signal, which is a power saving signal, in a power supply part of a conventional display apparatus. As shown in FIG. 3, the power supplying part includes a rectifying part 100 converting AC power supplied from an outside source to DC power (voltage), a switching transformer 200 transforming the DC voltage outputted from the rectifying part 100 to an output voltage (Vout:B+) applied to a display device (not shown), a transformer driving part 300 controlling a switching operation of the switching transformer 200, a synchronous circuit part 600 providing a switching driving signal to the transformer driving part 300, a deflection IC 700 providing a synchronizing signal or a horizontal synchronizing signal H-Sync of a computer body (not shown), a micro controller (MICOM) 500 providing the power saving signal (DPMS signal) which controls an output of the switching transformer 200 based on the synchronizing signal, and a feedback circuit 400 generating a feedback signal according to an output level of the switching transformer 200 and providing the feedback signal to the transformer driving part 300.

The micro controller 500 displays images on the display device by providing the synchronizing signal transmitted from the computer body to the deflection IC 700. Here, the micro controller 500 is operated by receiving one of voltages outputted through a secondary winding of the switching transformer 200 as a driving power source. The DPMS signal from the micro controller 500 is provided to the transformer driving part 300 through the feedback circuit 400 to control the output voltage of the switching transformer 200, thereby implementing the power saving function.

In the meanwhile, the feedback circuit 400 controls the switching operation of the transformer driving part 300 to allow the output voltage outputted from the switching transformer 200 to be stabilized.

The synchronizing circuit part 600 receives a horizontal synchronizing signal H-Sync from the deflection IC 700 and synchronizes a frequency (output timing) of the output voltage outputted according to the switching operation of the transformer driving part 300 with the horizontal synchronizing signal H-Sync, thereby preventing noise.

The transformer driving part 300 drives the switching transformer 200 by outputting the pulse width modulation wave having a predetermined frequency and duty, to thereby allow the stabilized output voltage to be outputted. Here, the transformer driving part 300 can use another voltage induced from a separate winding provided in the switching transformer 200 as a driving electric source.

According to the non-use of the computer system body, the display apparatus enters into the power off mode of the power saving modes, but a 5V voltage needs to be continuously applied to the micro controller 500 receiving the horizontal synchronizing signal H-Sync in order to return to the normal mode. Thus, a power consumption efficiency is lowered even though an output of the switching transformer is maintained in a lowest level in the power off mode.

### SUMMARY OF THE INVENTION

Accordingly, it is an aspect of the present invention to provide a power control system for a display apparatus to enhance a power saving efficiency by reducing maximally a voltage outputted from a switching transformer in a power saving mode.

Additional aspects and advantages of the invention will be set forth in part in the description which follows and, in part, will be obvious form the description, or may be learned by practice of the invention.

The foregoing and/or other aspects of the present invention are achieved by providing a power control system for a display apparatus including a rectifying part converting AC power to DC power, a switching transformer transforming a DC voltage outputted from the rectifying part into an output voltage applied to the display apparatus, a switching controller controlling a switching operation of the switching transformer, a feedback winding provided in the switching transformer and generating a feedback current induced by a primary winding of the switching transformer to provide the induced feedback current to the switching controller, a micro controller generating a switching driving signal synchronized with a horizontal synchronizing signal provided from a computer body in a normal mode and a generating power saving mode signal reducing the output voltage of the switching transformer in a power saving mode, and a synchronous circuit part receiving the switching driving signal or the power saving mode signal from the micro controller to provide the switching driving signal or the power saving mode signal to the switching controller.

According to another aspect of the invention, the micro controller cuts off the switching driving signal from being provided to the switching controller through the synchronous circuit part after generating the power saving mode signal, and the switching controller controls the switching operation so that the output voltage of the switching transformer can be reduced according to an amount of the feedback current generated from a feedback winding of the switching transformer when the switching driving signal is cut off.

According to another aspect of the invention, the micro controller cuts off power provided to the micro controller after providing the power saving mode signal to the synchronous circuit part.

According to another aspect of the invention, the switching controller controls the switching operation of the switching transformer so that the output voltage of the switching transformer can be stabilized according to a variation of the feedback current provided from the feedback winding.

According to another aspect of the invention, the switching controller controls the switching operation of the switching transformer so that the output voltage having a frequency (output timing) synchronized with the switching driving signal in the normal mode can be generated.

According to another aspect of the present invention, a power control system for a display apparatus including a rectifying part converting AC power to DC power, a switching transformer transforming a DC voltage outputted from the rectifying part into an output voltage applied to the display apparatus, and a switching controller controlling a switching operation of a primary winding of the switching transformer, includes a feedback winding provided in the switching transformer to generate a feedback current induced by the primary winding of the switching transformer to provide the induced current to the switching controller, and a micro controller generating a switching driving signal and a power saving mode signal. The switching controller generates a first switching signal to control the switching operation of the switching transformer according to the switching driving signal and generates a second switching signal to control the switching operation of the switching transformer according to the induced current and the power saving mode.

According to another aspect of the present invention, the power control system includes a feedback winding provided in the switching transformer to generate a feedback current induced by the primary winding of the switching transformer to provide the induced current to the switching controller, and a micro controller generating a switching driving signal and a power saving mode signal according to a synchronized signal transmitted from an external source. A switching controller generates a switching signal according to the switching driving signal or the induced current and the power saving mode signal to control a switching operation of the switching transformer. The first switching signal is synchronized with the synchronization signal.

### BRIEF DESCRIPTION OF THE DRAWINGS

These and/or other aspects and advantages of the present invention will become apparent and more readily appreciated from the following description of the preferred embodiment, taken in conjunction with the accompanying drawings of which:

FIG. 1 is a block diagram of a power control system for a display apparatus according to an embodiment of the present invention;

FIG. 2 is a view illustrating an output voltage control operation of the power control system of FIG. 1; and

FIG. 3 is a block diagram of a power control system for a conventional display apparatus.

### DETAILED DESCRIPTION OF THE PREFERRED EMBODIMENT

Reference will now be made in detail to the embodiment of the present invention, examples of which are illustrated in the accompanying drawings, wherein like reference numerals refer to like elements throughout. The embodiment is described below in order to explain the present invention by referring to the figures.

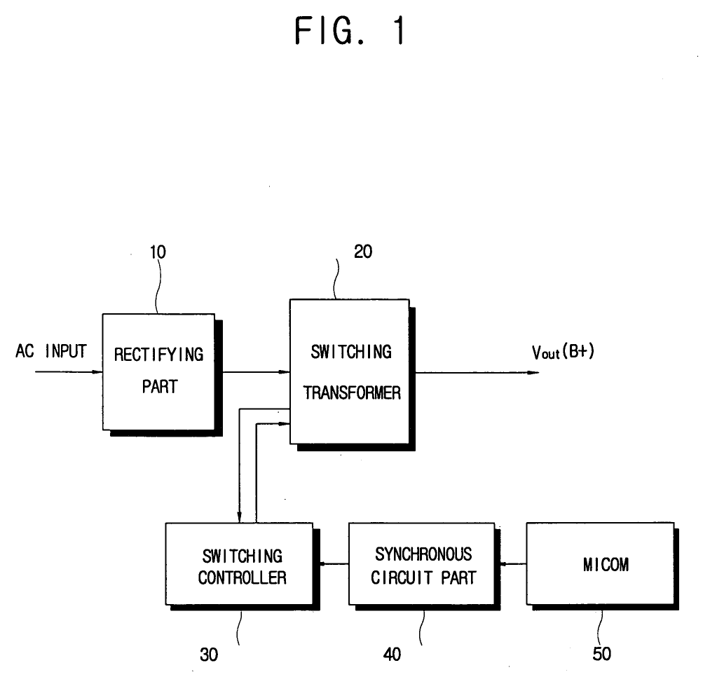

FIG. 1 is a block diagram of a power control (supply) system for a display apparatus according to an embodiment of the present invention. As shown in FIG. 1, the power supply system includes a rectifying part 10 converting AC power supplied from an external source into DC power, a switching transformer 20 transforming a DC voltage outputted from the rectifying part 10 into an output voltage (Vout:B+) applied to respective devices (not shown) of the display apparatus, a switching controller 30 controlling a switching operation of the switching transformer 20, a synchronous circuit part 40 providing a switching driving signal or a power saving mode signal to the switching controller 30, a micro controller 50 generating the switching driving signal and the power saving mode signal based on a synchronizing signal (horizontal synchronizing signal) provided from a computer system body (not shown) and providing the switching driving signal and the power saving mode signal to the synchronous circuit part 40.

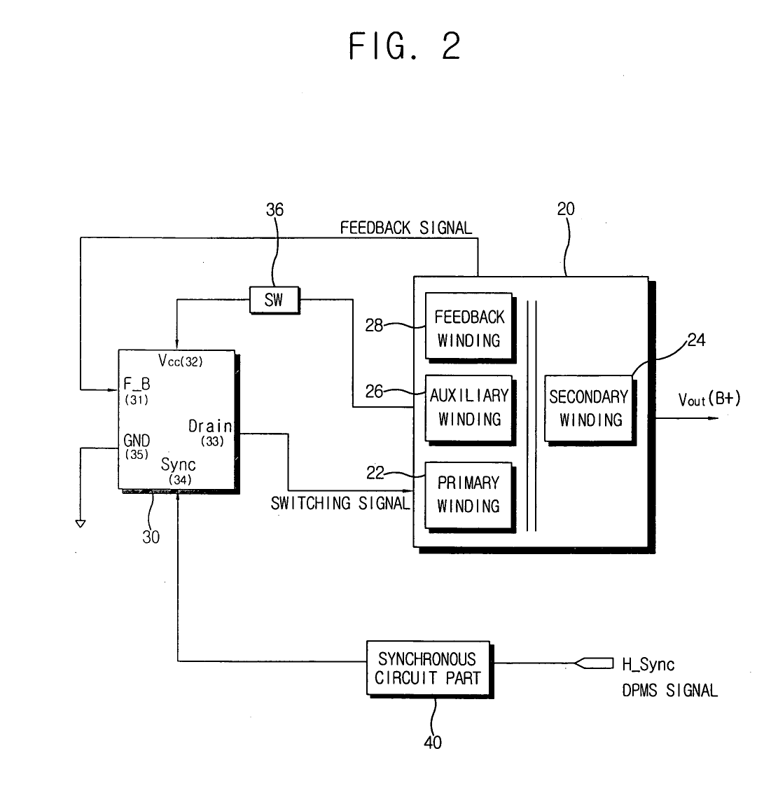

Here, the switching transformer 20 is provided with a feedback winding 28 (refer to FIG. 2) generating a feedback signal according to a feedback current induced by a primary winding 22 (refer to FIG. 2) of the switching transformer 20 (to be described later) and providing the feedback signal to the switching controller 30. The output voltage of the switching transformer 20 is converted into various voltages necessary for driving respective parts (devices) of the display apparatus including the micro controller 50 and provided thereto. Here, the micro controller 50 generally receives a 5V voltage among the output voltages converted and outputted from the switching transformer 20.

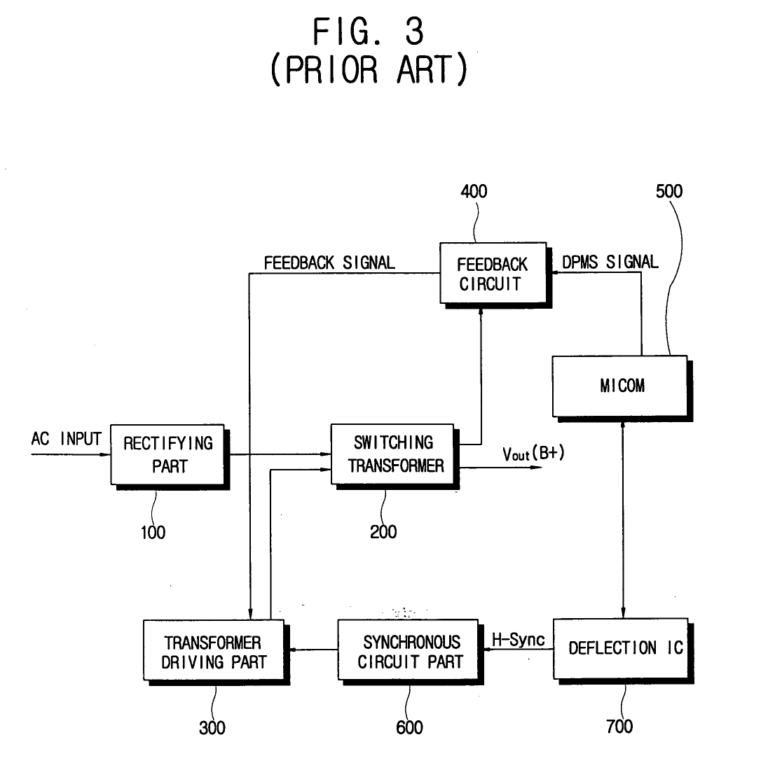

The micro controller 50 generates the switching driving signal synchronized with the horizontal synchronizing signal provided from the computer system body during the normal mode and provides the switching driving signal to the switching controller 30 through the synchronous circuit part 40. The micro controller 50 generates the power saving mode signal to reduce the output voltage of the switching transformer 20 during the power saving mode and provides the power saving mode signal to the switching controller 30 through the synchronous circuit part 40. In a conventional power supply system shown in FIG. 3, the power saving mode signal generated from a micro controller 500 was provided to a transformer driving part through a feedback circuit. However, according to the present invention, the power saving mode signal generated from the micro controller 50 is provided to the switching controller 30 through the synchronous circuit part 40, to control the output voltage of the switching transformer 20. That is, the micro controller 50 generates the power saving mode signal and then, the switching driving signal according to the horizontal synchronizing signal is cut off from being provided to the switching controller 30. Accordingly, the switching controller 30 controls the switching operation of the switching transformer 20 so that the output voltage of the switching transformer 20 is reduced based on an amount of the feedback current generated from the feedback winding 28 according to cutoff of the switching driving signal.

FIG. 2 is a view illustrating a control process of outputting the output voltage by the switching controller 30 and the switching transformer 20 in the power supply system of the display apparatus of FIG. 1 in detail. As shown in FIG. 2, the switching controller 30 includes a feedback terminal (F_B) 31 in which the feedback signal is inputted, a power input terminal (Vcc) 32 through which a driving power is supplied, a switching signal terminal (Drain) 33 providing a switching signal to the switching transformer 20, a synchronizing signal terminal (Sync) 34 into which a control signal from the synchronous circuit part 40 is inputted, and a ground terminal (GND) 35.

If synchronizing signals are provided from the computer system body (not shown) in order to display an image on the display apparatus, the switching driving signal of the micro controller 50 corresponding to the horizontal synchronizing signal is inputted into the synchronous circuit part 40. Accordingly, the synchronous circuit part 40 provides the switching driving signal to the switching controller 30 through the synchronizing signal terminal 34.

During an initial operation of the display apparatus, the DC voltage converted in the rectifying part 10 is supplied to the power input terminal (Vcc) 32, so that the switching controller 30 can be operated. According to an operation of the switching controller 30, the switching driving signal inputted from the synchronous circuit part 40 is outputted through the switching signal terminal 33, so that an pulse type energy can be induced from the primary winding 22 to a plurality of secondary windings 24 in the switching transformer 20. The pulse type energy induced to the secondary winding 24 is converted to a predetermined DC voltage (B+ or the output voltage) according to a winding ratio. In the meanwhile, another induced energy to an auxiliary winding 26 separated from the secondary winding 24 of the switching transformer 20 is converted to another DC voltage through a rectifier (not shown), and the another DC voltage is provided to the switching controller 30 as a driving voltage of the switching controller 30. Here, a switch part 36 can be provided between the switching controller 30 and the rectifying part 10 and/or the auxiliary winding 26 so that the DC voltage provided from the rectifying part 10 at a starting (initial) operation of the display apparatus, and the another DC voltage provided from the switching transformer 20 after the starting operation, can be switched to the switching controller 30, so that one of the DC voltage and the another DC voltage is provided to the switching controller 30.

The feedback winding 28 of the switching transformer 20 generates the feedback signal according to the feedback current induced by the primary winding 22 and provides the feedback signal to the switching controller 30. In a case that the display apparatus operates in the normal mode, the switching driving signal outputted from the switching controller 30 is adjusted based on the feedback signal generated according to a variation of the feedback current generated from the feedback winding 28, to stabilize the output voltage (B+) of the switching transformer 20. Also, the switching driving signal generated from the micro controller 50 corresponding to the horizontal synchronizing signal transmitted from the computer system body is inputted to the synchronizing signal terminal 34 of the switching controller 30 through the synchronous circuit part 40. Accordingly, the switching operation of the switching transformer 20 is controlled by the switching controller 30, and a frequency (output timing) of the output voltage outputted from the secondary winding 24 of the switching transformer 20 is synchronized with the horizontal synchronizing signal to prevent noise from occurring.

In a case that the display apparatus operates in a power saving mode, particularly in a case of a power off mode in which even the horizontal synchronizing signal is cut off, the micro controller 50 generates the power saving mode signal (DPMS signal) and provides the power saving mode signal to the synchronous circuit part 40, and cuts off the switching driving signal corresponding to the horizontal synchronizing signal to prevent the switching driving signal from being provided to the synchronous circuit part 40. In the meanwhile, power provided to the micro controller 50 is also cut off. Accordingly, if the DPMS signal is inputted into the synchronizing signal terminal 34 of the switching controller 30, the variation of the feedback signal occurs by the feedback current generated from the feedback winding 28 according to the cutoff of the switching driving signal outputted through the switching signal terminal 33. Thus, the switching operation of the switching transformer 20 is controlled so that the induced energy from the primary winding 22 to the secondary winding 24 is reduced and outputted.

Like this, in the case of the power off mode in which even the horizontal synchronizing signal is cut off, not only the output voltage of the switching transformer 20 is minimized, but also the power provided to the micro controller 50 is cut off according to the present invention, thereby increasing a power saving efficiency because a power consumption can be maintained lower than 1W. In the power off mode of the power saving mode, if the synchronizing signal is provided from the computer system body again, the horizontal synchronizing signal is provided to the switching controller 30 through the synchronous circuit part 40 because the micro controller 50 is cut off from the power, so that the switching transformer 20 can output the output voltage needed to each part (device) of the display apparatus. Accordingly, the micro controller 50 starts a normal operation again.

Like this, in the case of the power off mode that horizontal and vertical synchronizing signals are not active, the micro controller 50 cuts off the power provided from the switching transformer 20 to the display apparatus, so that the power consumption can be minimized. Here, the voltage applied to the micro controller 50 conventionally needing the 5V is also cut off, so that the consumption power is lowered to 1W or less in the power off mode of the power saving mode, thereby sufficiently coping with the DPMS standard which is gradually enhanced. Also, the switching operation of the switching transformer 20 is controlled by the feedback signal of the feedback winding 28 provided in the switching transformer 20. Thus, the output voltage of the switching transformer 20 can be stabilized, and the noise caused by an interference between output circuits of the display apparatus can be removed by synchronizing the frequency (output timing) of the output voltage with the switching driving signal corresponding to the horizontal synchronizing signal provided from the synchronous circuit part 40.

As described above, in the power off mode of the power saving mode, the power saving efficiency is increased by minimizing the output voltage outputted from the switching transformer. Also, the noise can be reduced by stabilizing the output voltage outputted from the switching transformer and by synchronizing the frequency (output timing) of the output voltage with the horizontal synchronizing signal.

Although an embodiment of the present invention has been shown and described, it will be appreciated by those skilled in the art that changes may be made in these embodiments without departing from the principles and spirit of the invention, the scope of which is defined in the appended claims and their equivalents.

What is claimed is:

1. A power control system for a display apparatus including a rectifying part converting AC power to DC power, a switching transformer having a primary winding and transforming a DC voltage outputted from the rectifying part into an output voltage applied to the display apparatus, and a switching controller controlling a switching operation of the switching transformer, the power control system comprising:
a feedback winding provided in the switching transformer to generate a feedback current induced by the primary winding of the switching transformer to provide the induced current to the switching controller;
a micro controller generating a switching driving signal synchronized with a horizontal synchronizing signal provided from an external source in a normal mode, and generating a power saving mode signal to reduce the output voltage of the switching transformer in a power saving mode; and
a synchronous circuit part receiving the switching driving signal or the power saving mode signal from the micro controller, and providing the switching driving signal or the power saving mode signal to the switching controller;
wherein the switching controller controls the switching transformer according to the induced current, the power saving mode signal, and the switching driving signal.

2. The power control system for the display apparatus according to claim 1, wherein the micro controller cuts off the switching driving signal so that the switching driving signal cannot be provided to the switching controller through the synchronous circuit part after the power saving mode signal is generated, and the switching controller controls the switching operation of the switching transformer so that the output voltage of the switching transformer can be reduced according to an amount of the feedback current generated from the feedback winding when the switching driving signal is cut off.

3. The power control system for the display apparatus according to claim 2, wherein the micro controller cuts off a portion of the output voltage of the switching transformer provided to the micro controller after the power saving mode signal is provided to the synchronous circuit part.

4. The power control system for the display apparatus according to claim 1, wherein the switching controller controls the switching operation of the switching transformer to stabilize the output voltage of the switching transformer according to a variation of the feedback current provided from the feedback winding.

5. The power control system for the display apparatus according to claim 4, wherein the switching controller controls the switching operation of the switching transformer so that the output voltage having a frequency synchronized with the switching driving signal in the normal mode is generated.

6. A power control system for a display apparatus including a rectifying part converting AC power to DC power, a switching transformer transforming a DC voltage outputted from the rectifying part into an output voltage applied to the display apparatus, and a switching controller controlling a switching operation of a primary winding of the switching transformer, the power control system comprising:
a feedback winding provided in the switching transformer to generate a feedback signal induced by the primary winding of the switching transformer to provide the induced feedback signal to the switching controller; and
a micro controller generating a switching driving signal and a power saving mode signal;
wherein the switching controller generates a first switching signal to control the switching operation of the switching transformer according to the switching driving signal and generates a second switching signal to control the switching operation of the switching transformer according to the induced feedback signal and the power saving mode signal.

7. The power control system for the display apparatus according to claim 6, wherein the micro controller receives a synchronization signal from an external source and generates the switching driving signal in response to the synchronization signal.

8. The power control system for the display apparatus according to claim 7, wherein the micro controller generates the power saving mode signal when the micro controller does not receive the synchronization signal from the external source.

9. The power control system for the display apparatus according to claim 7, wherein at least one of the first and second switching signals is synchronized with the synchronization signal.

10. The power control system for the display apparatus according to claim 7, wherein the switching transformer comprises a secondary winding generating a first output voltage and a second output voltage according to the first and second switching signals, respectively, and at least one of the first and second output voltages has a frequency synchronized with the synchronization signal.

11. The power control system for the display apparatus according to claim 6, wherein the switching transformer comprises a secondary winding generating a first output voltage when the switching controller generates the first switching signal according to the switching driving signal, and a second output voltage when the switching controller generates the second switching signal according to the power saving mode signal.

12. The power control system for the display apparatus according to claim 11, wherein the second output voltage is equal to or lower than 5V or the first output voltage.

13. The power control system for the display apparatus according to claim 6, wherein the switching transformer comprises an auxiliary winding generating another DC power according to the switching operation of the primary winding, and the switching controller receives one of the DC power of the rectifying part and the other DC power of the auxiliary winding as a driving voltage of the switching controller.

14. The power control system for the display apparatus according to claim 13, wherein the switching controller receives the DC power of the rectifying part when the switching controller does not control the switching operation of the primary winding.

15. The power control system for the display apparatus according to claim 13, wherein the switching controller receives the other DC power of the auxiliary winding when the switching controller controls the switching operation of the primary winding.

16. The power control system for the display apparatus according to claim 6, wherein the power saving mode signal is not directly transmitted to the primary winding of the switching transformer to perform the switching operation of the primary winding.

17. A power control system for a display apparatus including a rectifying part converting AC power to DC power, a switching transformer transforming a DC voltage outputted from the rectifying part into an output voltage applied to the display apparatus, and a switching controller controlling a switching operation of a primary winding of the switching transformer, the power control system comprising:
a feedback winding provided in the switching transformer to generate a feedback signal induced by the primary winding of the switching transformer to provide the induced feedback signal to the switching controller; and
a micro controller generating a switching driving signal and a power saving mode signal according to a synchronized signal transmitted from an external source;
wherein the switching controller generates a switching signal according to the switching driving signal or the induced feedback signal and the power saving mode signal to control the switching operation of the switching transformer, the switching signal being synchronized with the synchronization signal.

18. The power control system for the display apparatus according to claim 17, wherein the switching controller generates a pulse signal as the switching signal, and a frequency of the pulse signal is synchronized with the synchronization signal.

19. The power control system for the display apparatus according to claim 17, wherein the switching transformer comprises a secondary winding generating the output voltage according to the switching operation of the primary winding, and the output voltage has a frequency synchronized with the synchronization signal.

20. The power control system for the display apparatus according to claim 19, wherein the output voltage and the switching signal are synchronized with the synchronization signal.
